(19) United States
(12) Patent Application Publication
(10) Pub. No.: US 2002/0094397 A1
(43) Pub. Date: Jul. 18, 2002

(54) Sterilisible composite film

(76) Inventors: Wilfried Jud, Singen (DE); Rudolf Janacek, Kreuzlingen (CH); Joachim Pietzsch, Gottmadingen (DE)

Correspondence Address: Fisher Christen & Sabol, Suite 1401, 1725 K Street, N.W., Washington, DC, 20006, US

(21) Appl. No.: 10/083,110

(22) Filed: Feb. 27, 2002

Related U.S. Application Data
(63) Continuation of application No. 09/879,903, filed on Jun. 14, 2001.
Application No. 09/879,903 is a continuation of application No. 09/457,006, filed on Dec. 8, 1999, now abandoned.

(30) Foreign Application Priority Data
Dec. 16, 1998 (EP) 98811232.2

(51) Int. Cl. B32B 1/08; B32B 15/08

(52) U.S. Cl. 428/35.3; 428/458; 428/35.9; 428/215; 428/216

(57) ABSTRACT

Sterilizible composite film for manufacturing pouch type forms of packaging and the like for e.g. liquid, pasty or solid foodstuffs. The sterilizible composite films according to the present invention contain a barrier layer that is impermeable to water vapor and gases and is in the form of a metal foil. On both sides of the barrier layer is at least one functional layer. The following layers are arranged on top of each other in the composite film:

a) a first functional layer containing a plastic film of the polyester or polyolefin type or an extrusion layer of polyolefins or one or more print and lacquer layers or print layers and

b) a metal foil and

c) a second functional layer in the form of a plastic film of co-extruded polyamide/polypropylene type.

The present invention relates to a sterilisible composite film containing a barrier layer that is impermeable to water vapour and gases comprising a metal foil and on both sides of the barrier layer at least one functional layer; the invention also embraces the use of the composite film.

Known are sterilisible composite films, e.g. those employed in the manufacture of pouches for packaging foodstuffs for human and animal consumption. For example composites made out of plastic films or plastic laminates and a barrier layer impervious to water vapour and gases in the form of a metal foil are processed into pouches by stamping or cutting and/or folding and sealing. An example of such a composite film is a four layer composite containing one after another e.g. a polyester film, an aluminium foil, an oriented polyamide film and a polypropylene film. The PETP film provides the strength, the polyamide acts supportively in the composite and the generally relatively thick polypropylene film improves the resistance to penetration and can be sealed. Each of the four layers is joined to the neighbouring layers by means of an adhesive and, in some cases by an additional bonding agent and/or primer.

It can be seen that manufacturing such a composite is complicated. The many layers involved makes it necessary to employ a corresponding number of passes through the machine, and—as a result of the many layers of adhesive—it is possible that delamination occurs under the conditions of sterilisation.

The object of the present invention is to propose a composite film which has a simple structure, withstands the sterilisation conditions and can be easily processed into pouches.

That objective is achieved by way of the invention in that the composite film exhibits a layer structure containing one on top of the other:

a) a first functional layer containing a plastic film from the polyester or polyolefin series, or is an extrusion layer of polyolefins, or one or more lacquer layers or print and lacquer layers or print layers and

b) a metal foil and

c) a second functional layer in the form of a plastic film of the co-extruded polyamide/polypropylene film type.

Preferred are sterilisible composite films that exhibit a layer structure containing one on top of the other:

a) a plastic film from the polyester series and

b) a metal foil and

b) a plastic film of the co-extruded polyamide/polypropylene film type.

Further preferred sterilisible composite films according to the present invention are such containing one after the other:

a) one or more lacquer layers, or print and lacquer layers, or print layers and

b) a metal foil and

c) a plastic film of the co-extruded polyamide/polypropylene film type.

The metal foils may have a thickness e.g. of 5 to 100 μm, usefully from 7 to 25 μm and preferably from 7 to 15 μm.

The metal foil may be of steel, iron or copper and is preferably an aluminium foil. The aluminium foil may be of pure aluminium or usefully an aluminium alloy of the type AlMn, AlFeMn, such as AlFe1.5Mn, AlFeSi or AlFeSiMn, for example having a purity of 97.5% and higher, preferably 98.5% and higher. The metal foil is preferably an uninterrupted foil, texture free and homogeneous.

The metal foil or aluminium foil has either not been pre-treated with a primer or is e.g. pre-treated with a primer on one or both sides.

Suitable primers may e.g. be chosen from the epoxy resin or polyurethane series.

In the case of plastic films of the polyester type this may be a monofilm or a composite film of two or more layers. The plastic films of the polyester type may be non stretched or may be uniaxially or biaxially stretched. The plastic films of the polyester series may have a thickness e.g. of 8 to 25 μm, usefully 10 to 18 μm and preferably 12 μm.

Examples of polyester type films are polyalkylene-terephthalates or polyalkylene-iso-phthalates with alkylene groups or radicals with 2 to 10 carbon atoms or alkylene groups with 2 to 10 C atoms that are interrupted by at least one O—, such as e.g. polyethylene-terephthalate, polypropylene-terephthalate, polybutylene-terephthalate (polytetramethylene-terephthalate), polydecamethylene-terephthalate, poly-1,4-cyclohexyldimethylole-terephthalate or polyethylene-2,6-napthalene-dicarboxylate or mixed polymers of polyaklylene-terephthalate and polyalkylene-isophthalate, where the fraction of isophthalate amounts e.g. to 1 to 10 mol %, mixed polymers and terpolymers, and block polymers and grafted modifications of the above mentioned substances. Other useful polymers are known in the field under the abbreviation PEN.

Other polyesters are copolymers of terephthalic acid and a further polycarboxyl acid with at least one glycol. Useful in that respect are the copolymers of terephthalic acid, ethylene glycol and a further glycol. Preferred are glycol-modified polyesters known in the field as PETG.

Further useful polyesters are polyalkylene-terephthalate with alkylene groups or radicals with 2 to 10 carbon atoms and polyalkylene-terephthalates with alkylene groups or radicals with 2 to 10 carbon atoms, that are interrupted by one or two —O—. Further preferred polyesters are polyalkylene-terephthalates with alkylene groups or radicals with 2 to 4 carbon atoms. Belonging to these polyalkylene-terephthalates are also A-PET, PETP and the so-called PETG or C-PET. Very highly preferred are polyalkylene-terephthalate films of the PETP type. The films of polyester may be non-stretched or uniaxially or, preferably, biaxially oriented.

The plastic films of the polyolefin series may be a monofilm or a composite film made up of two or more layers. The plastic films of the polyolefin series may be non-stretched, uniaxially or biaxially oriented. The plastic films of the polyolefin series may exhibit a thickness of 8 to 30 μm, usefully 10 to 23 μm, preferably from 12 to 18 μm.

The extrusion layers of polyolefin; may be an extrusion layer or a co-extrusion layer. The weight per unit area of the extrusion layer or co-extrusion layer may be e.g. from 8 to 25 g/m², preferably from 10 to 20 g/m².

Examples of polyolefins for the films or extrusion coatings are polyethylenes such as low, medium or high density polyethylenes or linear polyethylenes of low, medium or high density, special preference being given to high density polyethylenes. Further examples are copolymers or terpolymers of ethylene with acrylic acid (EAA, ethyl acrylic acid), of ethylene acrylic esters such as methacrylrate (EMA), ethyl acrylate (EEA) or butyl acrylate (EnBA), of ethylene with vinyl acetates (EVA), of ethylene with methacrylic acid (EMMA) or of ethylene with ethyl acrylate and acrylic acid (EAEAA) or ionomer resins. Further examples of a polyolefin that can be mentioned are polypropylenes. The polypropylene for films or extrusion coatings may be an isotactic, syndiotactic or atatic polypropylene or a mixture thereof. The polypropylene may be amorphous, partially crystalline or highly crystalline. Also block polymers or random copolymers of polypropylene may be employed. The average molar mass may be e.g. from less than 10,000 to 600,000 or higher. Also copolymers, such as ethylene/propylene-block or multiblock-copolymers and poly-blends such as caoutchouc modified polypropylene and of polypropylene may be employed. For example, ethylene/propylene-block copolymers may contain up to 59 wt. % polyethylenes such as e.g. high density polyethylene (HDPE).

The layers and films of polyolefins may be non stretched, or they may be uniaxially or preferably biaxially oriented.

The plastic film of co-extruded polyamide/polypropylene is preferably prefabricated, made from the two polymers. The plastic film of co-extruded polyamide/polypropylene may have a thickness e.g. of 50 to 120 μn, usefully 60 to 90 μm, preferably 70 to 80 μm. The thickness of the polyamide layer in the co-extruded polyamide/polypropylene film amounts to e.g. 5 to 50%, usefully 10 to 30%, and in particular 15 to 25% of the overall thickness of the co-extruded film.

The films of co-extruded polyamide/polypropylene may be non stretched, or they may be uniaxially or preferably biaxially oriented.

The co-extruded films of co-extruded polyamide/polypropylene may exhibit a polyamide layer e.g. of polyamide 6, a homopolymeride of ε-caprolactam (polycaprolactam); polyamide 11, polyamide 12, a homopolymeride of •-laurinlactam (polylaurinlactam); polyamide 6.6, a homopolymer condensate of hexa-methylene-diamine and adipinic acid (poly-hexamethylene-adipamide); polyamide 6.10, a homopolymer condensate of hexa-methylenediamine and sebacinic acid (poly-hexa-methylene-sebacamide); polyamide 5.12, a homopolymer condensate of hexa-methylene-diamine and dodecandic acid (poly-hexa-methylenedodecanamide) or polyamide 6-3-T, a homopolymer condensate of trimethyl-hexamethylenediamine and terephthalic acid (poly-trimethyl-hexamethylene-terephthalamide, and mixtures thereof. The co-extruded layer of polyamides is to advantage non stretched. The films of polyamides are either non stretched or are uniaxially or biaxally oriented.

Examples of polypropylenes in the plastic film of co-extruded polyamide/polypropylene may be taken from the above mentioned list.

The polypropylene layer in the plastic film of co-extruded polyamide/polypropylene normally faces the inside or the contents of the container made from the composite film according to the invention. Likewise the polyamide layer is bonded to the metal foil.

The composite films here may be sealed by means of the outer lying polypropylene layer of the co-extruded film. In some cases sealing layers such as sealing films, hot organic sealing coatings or organic sealing coatings e.g. on the basis of polyolefins such as polyethylenes, copolymers and terpolymers of ethylene, preferably EAA, polypropylenes or mixtures thereof, also polyacrylates, PVC resins, polyvinyliden chlorides, EVA, polyethylene terephthalates, in particular those of the A-PET type, etc. may be deposited on the polypropylene and on the other free side of the composite film in order to control the sealing properties. The free side, in particular the of the polyester film, may be coated with EVA (ethylene/vinyl alcohol copolymer) or with an amorphous polyester sealing layer of the A-PET type.

The individual layers i.e. the first functional layer and thereby the plastic film a) from the series of polyester films or polyolefin films or polyolefin layers facing the metal foil and/or the second functional layer facing the metal foil and any sealing films on the free side of the composite film may be joined together by means of a bonding agent and/or laminate adhesive.

Suitable laminate adhesives may be solvent-containing or solvent-free and water-containing. Examples of laminate adhesives are solvent-containing, solvent-free or aqueous acrylic adhesives or polyurethane adhesive systems. However, also adhesives that harden under the influence of radiated energy (e.g. ultra violet, electron beam radiation) may be employed. In view of the preferred application of the composite material in the field of foodstuff packaging, adhesive systems that are totally acceptable from the physiological standpoint are to be given preference. Aliphatic adhesive systems are particularly suitable.

Products based on di-isocyanate or aliphatic polyesters may be employed as bonding agents.

The laminate adhesive and the bonding agent may be employed in amounts e.g. of 0.5 to 10 g/m2, preferably 2 to 8 g/m2 and in particular 3 to 6 g/m2. The laminate adhesives may also be employed in amounts resulting in layers having a thickness of at least 0.1 μm and at most 12 μm.

The surface of the metal foil may provide better adhesion properties for the adhesive or lacquer coatings or for an extrusion layer by an appropriate pre-treatment (e.g. brushing, chromate treatment, ionising treatment or treatment with ozone, flame or plasma). In order to assist and improve the bonding of the lacquer coatings, bonding agents or laminate adhesives to the plastic films or extruded layers, it is often useful to provide the film with adequate surface tension on the side facing the adhesive or the extrudate. The increase in surface tension may be achieved advantageously by an ionising, ozone, plasma, flame or corona pre-treatment.

It may also be advantageous to join the first and/or second functional layer to the metal foil, without laminate adhesive and/or bonding agent, only under the action of pressure and heat.

In one possible version e.g. the plastic film a) of the polyester film type may exhibit a counter image on the side facing the metal foil. A counter image is particularly suitable for transparent and translucent films. It is also possible to provide the polyester film with a printed image on the outside and if desired to cover the image with a lacquer coating.

The composite films may exhibit, as a first functional layer a), one or more lacquer coatings or lacquer coatings and print layers on the outside or facing the outside viz., with respect to the container made from the film according to the invention. Print layers are in particular created by depositing material over part or the whole of the surface.

Protective coatings, pre-coatings, print materials and if necessary covering layers that come into question are e.g.:

Systems based on solvents (1) or systems with water as solvent (2) or systems that are dried or hardened by ultra violet or another form of radiation (3). The lacquer pre-coatings or covering layers (1) dissolved in solvents may be lacquer coatings with binding agent based on polyacrylate, polymethylacrylate, polyester, epoxide, cellulose nitrate, polyvinyl-chloride-acetate, polyvinylbutyral or mixtures of these binding agents, hardened with melaminic resins, ureic resins, polyisocyanates polyazirides or mixtures of these, if desired used along with acids, amines, calcium compounds, tin compounds as hardening accelerators and silanes, titanium or zirconium chelates as additives to promote bonding.

The corresponding printing materials may be made up in a similar manner, or they are often made up using non-hardening resins e.g. polyvinylbutyral or cellulose nitrate.

Aqueous systems (2) contain additionally tensides in order to achieve solubility. Use may be made of printing materials and covering layers (3) hardening under the influence of ultra-violet and other forms of radiation may be radical cross-linking printing materials and covering lacquer layers based on acrylates on conventional pre-coatings, as described above, printing materials that cross-link by a cationic mechanism as described above, print pre-coatings lacquer or UV- or radiation-hardening lacquer pre-coatings that cross-link by a cationic mechanism.

The lacquer layer or layers my be deposited by casting, spraying, wiping, deposition from a smooth roll etc., for example in each case in an amount of 0.5 to 10 g/m², in particular from 1.0 to 5 g/m².

If in addition to the lacquer coating or coatings or extrusion coatings, print layers or print layers alone are employed, then the printing of the composite film may be carried out using all known printing methods e.g. typographic, offset, flexo, screen, helio, and copper gravure printing. The choice of printing method to be employed depends on the desired quality of print, the prevailing technical aspects and on the number to be printed. It is possible to deposit single or multi-coloured layers of print on part or the whole of the surface area. Preferred is flexo-printing (also known as aniline or offset printing) and screen printing such as copper gravure printing, or helio-printing. The printing lies on the outward facing side of the composite material and e.g. in addition may have an overcoat of at least one further lacquer coating. For example, one, two, three or more lacquer coatings may be employed, the first lacquer coating lying on the metal foil or the pre-treated metal foil. In another version the printing may be deposited directly on the metal foil and if desired be covered by one, two, three or more lacquer layers. The last mentioned lacquer layers are, advantageously, transparent or translucent and act as protection for the printing. The printing may also be performed in several steps and at least one print layer covers the whole surface with the result that this total surface print layer or layers acts/act as a protective layer or layers. In another version the metal foil or pre-treated metal foil may have an overcoat of one or more lacquer layers. On top of this lacquer layer or layers comes whole area or partial area single or multi-coloured printing, which in some cases may be covered over with one or more lacquer layers, in particular transparent or translucent lacquer layers.

If desired the inner side of the composite may also be provided with a lacquer and/or printing.

The production of the composite film according to the invention may take place in a simple manner and in few process steps. The second functional layer c) is produced by co-extrusion and prepared for further processing. The second functional layer is laminate bonded to the metal foil via the polyamide layer. The first functional layer a) in the form of a polyester film is laminate coated onto the still free side of the metal foil or, the extrusion coating or the lacquer layer or layers, the print layer or layers, or lacquer and print layers, or the extrusion coating and print layers, are deposited in a single or multi-stage lacquering process and/or printing process. The sequence of the laminate coating process or lacquer coating and printing may be performed in an analogous manner also in a different order. Preferred in general is the sequence of laminate coating the first functional layer a) onto the metal foil or depositing the lacquer coating onto the metal foil and then laminate coating the second functional layer c) onto the free side of the metal foil.

The present invention also relates to pouch type forms of packaging of a sterilisible composite film according to the present invention. Pouch type forms of packaging may be made e.g. from a piece of composite material by folding and sealing, or from two side pieces of the said composite material by—if desired folding and—sealing, or from a plurality of side pieces of the composite material by—if desired folding and—sealing. Typical pouches are flat pouches, self-standing pouches, pouches sealed at the edges, pouches of given volume, self-standing pouches of given volume, side-seam flat pouches, rigid-base pouches, or bags such as welded flat or folded bags etc. The pouch-type forms of packaging may be employed for contents such a foodstuffs for human consumption or for animals or for semi-luxury items all of which may be in lump form, or in pulpy, pasty, semi-fluid or fluid form. Other examples of applications for such pouches are cosmetics or substances for personal hygiene in pasty to fluid form. Other examples are pharmaceutical products or preparations for remedial purposes. The composite films according to the present invention can be sterilised without suffering delamination of the individual layers or loss of strength e.g. by a thermal treatment at 110 to 130° C., preferably 121° C., for 10 to 60 minutes, preferably 30 minutes.

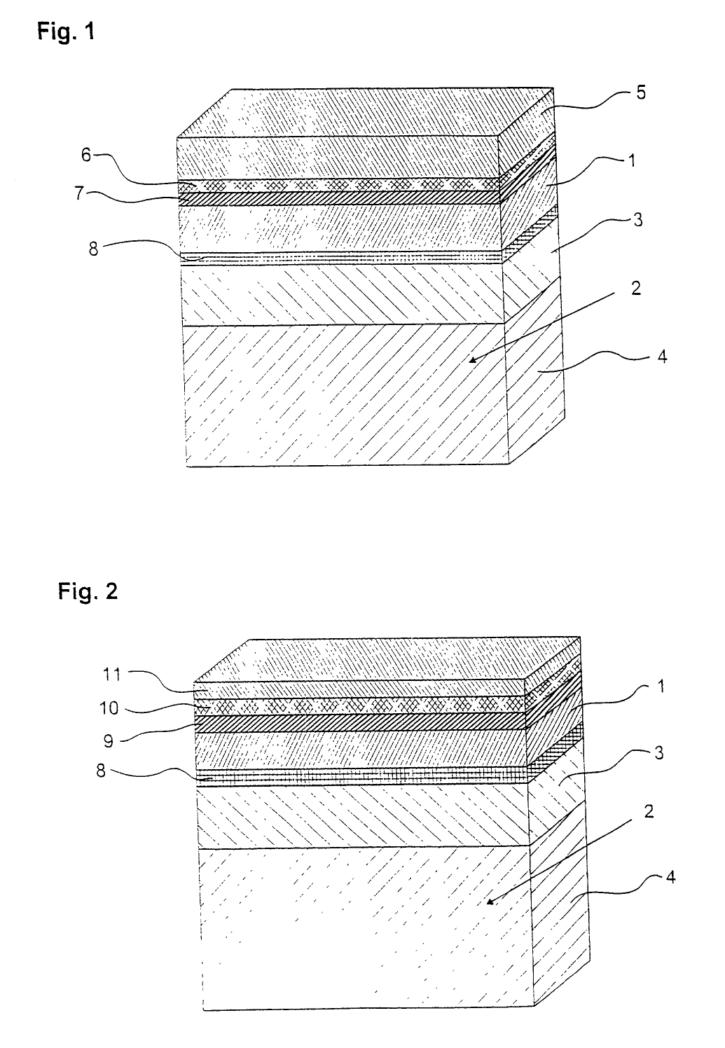

FIGS. 1 and 2 show schematically by way of example the make up of the composite film according to the invention.

The composite film shown in FIG. 1 features a metal foil 1. Laminate coated onto one side of the metal foil 1, by means of the laminate adhesive 7, is the first functional layer in the form of a PETP film 5. By way of example the PETP film 5 bears a counter-print 6. On the other side of the metal foil 1 is the second functional layer 2 in the form of a co-extrusion film comprising polyamide 3 and polypropylene 4, laminate bonded to the metal foil 1 by means of a laminate adhesive 8. When the composite film is in use, the polypropylene 4 of the co-extruded film 2 faces the contents of the packaging made from the composite film.

The composite film shown in FIG. 2 features a metal foil 1. On one side of the metal foil 1 is the first functional layer in the form of print and lacquer layers. Directly on the metal foil 1 is a pre-coating of lacquer 9, on top of this the surface print 10 and finally the protective lacquer. On the other side of the metal foil 1 is the second functional layer 2 in the form of a co-extrusion film comprising polyamide 3 and polypropylene 4 laminate bonded to the foil 1 by means of a laminate adhesive 8. Also in this application of the composite film the polypropylene 4 of the co-extrudate 2 faces the contents of the packaging made from the composite film.

1. Sterilisible composite film containing a barrier layer that is impermeable to water vapour and gases comprising a metal foil and on both sides of the barrier layer at least one functional layer, characterised in that, the composite film exhibits a layer structure containing one on top of the other:
a) a first functional layer containing a plastic film from the polyester or polyolefin series or an extrusion layer of polyolefins or one or more lacquer layers, or print and lacquer layers, or print layers and
b) a metal foil and
c) a second functional layer in the form of a plastic film of the co-extruded polyamide/polypropylene film type.

2. Sterilisible composite film according to claim 1, characterised in that the composite film exhibits a layer type structure, containing in sequence:
a) a plastic film from the polyester series and
b) a metal foil and
c) a plastic film of the co-extruded polyamide/polypropylene film type.

3. Sterilisible composite film according to claim 1, characterised in that the polyester film of layer a) is monoaxially or biaxially stretched.

4. Sterilisible composite film according to claim 1, characterised in that the polyester film of layer a) is of the PETP type.

5. Sterilisible composite film according to claim 1, characterised in that the composite film exhibits a layer type structure containing in sequence:
a) one or more lacquer layers, or print and lacquer layers, or print layers and
b) a metal foil and
c) a second plastic film of the co-extruded polyamide/polypropylene film type.

6. Sterilisible composite film according to claim 1, characterised in that the polyester film of layer a) has a thickness of 8 to 25 μm, preferably from 10 to 18 μm, in particular 12 μm, that the metal foil has a thickness of 5 to 100 μm, preferably from 7 to 25 μm, in particular from 7 to 15 μm and that the co-extruded polyamide/polypropylene film has a thickness of 50 to 150 μm, preferably from 60 to 90 μm, in particular from 70 to 80 μm.

7. Sterilisible composite film according to claim 1, characterised in that the metal foil is an aluminium foil, usefully pure aluminium or an aluminium alloy of the type AlMn, AlFeMn, AlFeSi or AlFeSiMn, preferably having a purity of 97.5% and higher, in particular a purity of 98.5% and higher.

8. Sterilisible composite film according to claim 1, characterised in that the metal foil is pre-treated with a primer on one or both sides.

9. Sterilisible composite film according to claim 1, characterised in that a bonding agent and/or laminate adhesive is provided between the individual layers.

10. Pouch type of packaging made from a sterilisible composite film according to claim 1.
